(19) United States
(12) Patent Application Publication
(10) Pub. No.: US 2026/0141835 A1
(43) Pub. Date: May 21, 2026

(54) IMAGE DATA ACQUISITION METHOD, IMAGE DATA ACQUISITION DEVICE, TERMINAL DEVICE, AND DISPLAY CORRECTION SYSTEM

(71) Applicant: Sharp Display Technology Corporation, Kameyama City, Mie (JP)

(72) Inventors: Kei SHINADA, Kameyama City, Mie (JP); Kazuki TAKAHASHI, Kameyama City, Mie (JP); Kazuo NAKAMURA, Kameyama City, Mie (JP); Noriyuki TANAKA, Kameyama City, Mie (JP)

(21) Appl. No.: 19/121,038

(22) PCT Filed: Oct. 19, 2022
(86) PCT No.: PCT/JP2022/038992

§ 371 Date: Apr. 14, 2025

(51) Int. Cl. G09G 3/20; G09G 3/3208

(52) U.S. Cl. CPC G09G 3/2003; G09G 3/2007; G09G 3/3208; G09G 2320/0646; G09G 2320/0666; G09G 2320/0693

(57) ABSTRACT

A method for acquiring image data to generate correction data for performing luminance correction or chromaticity correction of a display screen of a display device, the method includes: issuing an instruction for capturing an image of the display screen to be corrected to a user within an imaging range of an imaging device used by the user, and further issuing an instruction for capturing an image of the display screen multiple times in which the display screen is moved to other positions within the imaging range of the imaging device; and performing acquisition of a plurality of imaging data as image data captured by the user based on the instruction issued in the issuing an instruction for capturing an image of the display screen.

### TECHNICAL FIELD

The disclosure relates to an image data acquisition method, an image data acquisition device, a terminal device, and a display correction system for acquiring image data to generate luminance correction data.

### BACKGROUND ART

In the related art, in-plane luminance unevenness of a display panel such as a liquid crystal panel or a self-luminous panel (for example, an organic Electro Luminescence (EL) panel, and the like) has been reduced by a Demura (panel in-plane display unevenness removal) process at the time of factory shipment. For example, in PTL 1, an output image displayed on the display panel is captured by an imaging device, and the in-plane luminance unevenness of the display panel is reduced by using captured output image data.

### CITATION LIST

### Patent Literature

PTL 1: JP 2011-150349 A

### SUMMARY

### Technical Problem

However, in the related art as described above, since the output image data used for reducing the in-plane luminance unevenness of the display panel is the data captured by the imaging device, the in-plane luminance unevenness of the display panel cannot be appropriately reduced in some cases depending on in-plane distribution (unevenness caused by an imaging system) of detected luminance in an imaging range of the imaging device. Note that, when the imaging device in which the in-plane distribution of the detected luminance in the imaging range is sufficiently small to be ignored is used, or when the in-plane distribution of the detected luminance in the imaging range is automatically adjusted, the in-plane luminance unevenness of the display panel can be appropriately reduced even in the output image data obtained by imaging, but such an imaging device has high performance and is expensive.

In addition, even when the Demura process is performed to reduce the in-plane luminance unevenness of the display panel at the time of factory shipment, the in-plane luminance unevenness of the display panel due to time may occur again. In such a case, even when the technique described in PTL 1 is used again, as described above, the in-plane luminance unevenness of the display panel cannot be appropriately reduced in some cases. On the other hand, since the imaging device for appropriately reducing the in-plane luminance unevenness of the display panel is expensive and the installation location, the installation method, and the like are restricted, there is a problem in that it is not realistic to use the imaging device repeatedly over time (high hurdle).

In order to solve the above problem, an object of the disclosure is to provide an image data acquisition method, an image data acquisition device, a terminal device, and a display correction system capable of reducing in-plane luminance unevenness of a display panel in consideration of in-plane distribution of detected luminance in an imaging range of an imaging device by an inexpensive method not only at the time of factory shipment but also over time.

### Solution to Problem

An image data acquisition method according to an aspect of the disclosure is a method for acquiring image data to generate correction data for performing luminance correction or chromaticity correction of a display screen of a display device, the image data acquisition method including: issuing an instruction for capturing an image of the display screen to be corrected to a user within an imaging range of an imaging device used by the user, and further issuing an instruction for capturing an image of the display screen multiple times in which the display screen is moved to other positions within the imaging range of the imaging device; and performing acquisition of a plurality of imaging data as image data captured by the user based on the instruction issued in the issuing an instruction for capturing an image of the display screen.

An image data acquisition device according to an aspect of the disclosure is a device configured to acquire image data to generate luminance correction data for performing luminance correction or chromaticity correction of a display screen of a display device, the image data acquisition device including: an imaging instruction unit configured to issue an instruction for capturing an image of the display screen to be corrected to a user within an imaging range of an imaging device used by the user, and configured to further issue an instruction for capturing an image of the display screen multiple times in which the display screen is moved to other positions within the imaging range of the imaging device; and an imaging data acquisition unit configured to acquire a plurality of imaging data captured by the user as image data based on the instruction of the imaging instruction unit.

### Advantageous Effects of Disclosure

According to the disclosure, it is possible to reduce the in-plane luminance unevenness of the display panel by an inexpensive method and in consideration of the in-plane distribution of the detected luminance in the imaging range of the imaging device.

### BRIEF DESCRIPTION OF DRAWINGS

FIG. 1 is a schematic configuration block diagram of a smartphone according to a first embodiment of the disclosure.

FIG. 2 is a flowchart illustrating a flow of processing when an application for luminance correction processing is executed by an application execution unit in the smartphone illustrated in FIG. 1.

FIG. 3 is a diagram illustrating an image in which a user captures an image of a display panel of a display device using the smartphone.

FIG. 4 is a diagram illustrating an image data acquisition method by a camera included in the smartphone illustrated in FIG. 1.

FIG. 5 is a diagram illustrating an example of image data captured by the image data acquisition method illustrated in FIG. 4.

FIG. 6 is a diagram illustrating a method of removing external light reflection (reflection) included in the image data captured by the camera included in the smartphone illustrated in FIG. 1.

FIG. 7 is a diagram illustrating a method of coping with display panel position variations in the image data captured by the camera included in the smartphone illustrated in FIG. 1.

FIG. 8 is a diagram illustrating another method of coping with display panel position variations in the image data captured by the camera included in the smartphone illustrated in FIG. 1.

### DESCRIPTION OF EMBODIMENTS

### First Embodiment

A first embodiment of the disclosure will be described below. Here, an example will be described in which a correction table for correcting luminance unevenness of a display screen of a display device is generated by a terminal device used by a user, for example, a mobile terminal such as a smartphone or a tablet terminal.

### Smartphone

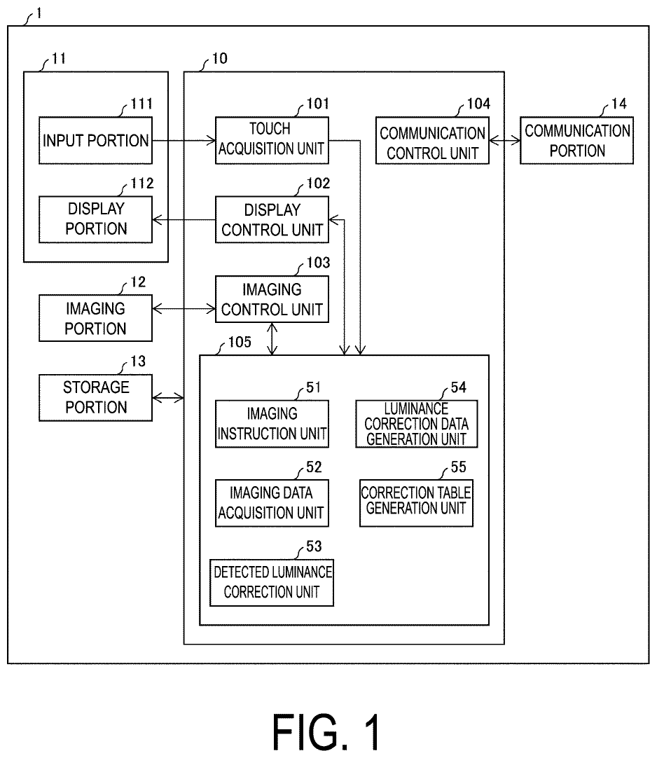

FIG. 1 is a schematic configuration block diagram illustrating a smartphone (imaging device) 1. The smartphone 1 includes a control unit 10, a touch panel 11, an imaging portion 12, a storage portion 13, and a communication portion (transmission portion) 14. The control unit 10 integrally controls each unit and portion of the smartphone 1. Details of the control unit 10 will be described below.

The touch panel 11 is an input and display panel formed by superimposing an input portion 111 that receives a touch input of a user and a display portion 112 that displays an image. The display portion 112 includes, for example, an organic EL panel, a liquid crystal panel, or the like, and displays various types of information using images, text, or the like. The input portion 111 functions as an operation portion that receives a touch input for performing various operations of the smartphone 1 based on information displayed on the display portion 112.

The imaging portion 12 is mounted with an imaging element (not illustrated). A Charge Coupled Device (CCD) sensor, a Complementary Metal Oxide Semiconductor (CMOS) sensor, or the like is used as the imaging element.

The storage portion 13 is a storage device that stores various types of data used in the smartphone 1. For example, the storage portion 13 stores luminance correction data, a correction table, and the like generated by a luminance correction application imaging device executed by the control unit 10.

The communication portion 14 can communicate with the display device including a display panel to be corrected and transmits data (correction table or the like) necessary for luminance correction of the display panel. When the display device is located near the smartphone 1, short-range communication such as Bluetooth (tradename) communication or infrared communication is used for communication between the communication portion 14 and the display device. Communication between the communication portion 14 and the display device may be performed via the Internet. For example, the communication portion 14 transmits data (the correction table and the like) necessary for the luminance correction of the display panel to the cloud via the Internet, and the display device receives the data necessary for the luminance correction of the display panel from the cloud as necessary.

The control unit 10 includes a touch acquisition unit 101, a display control unit 102, an imaging control unit 103, a communication control unit 104, and an application execution unit (image data acquisition device) 105.

The touch acquisition unit 101 acquires an electrical signal indicating a touch from the input portion 111 and calculates touch coordinates of the touch. Note that, in the disclosure, the term “touch coordinates” indicate touch coordinates (coordinates at the detection resolution of the touch panel) on the input surface of the input portion 111 converted into values indicating which pixel in the vertical and horizontal directions is touched on the coordinate display surface of the display surface of the display portion 112. The touch acquisition unit 101 supplies the calculated touch coordinates to the application execution unit 105. The touch acquisition unit 101 can hold the touch coordinates in a timeline. Then, touch information is supplied to the application execution unit 105 as a trajectory of touch operations (such as a drag operation or a long-press operation) that are continuously input over a certain period of time.

The display control unit 102 controls display of the display portion 112. For example, the display control unit 102 generates a screen in response to an instruction from the application execution unit 105 and causes the display portion 112 to display the screen.

The imaging control unit 103 controls imaging performed by the imaging portion (camera) 12. The imaging control unit 103 controls imaging performed by the imaging portion 12 based on an instruction from the application execution unit 105. The imaging data captured by the imaging portion 12 is supplied to the application execution unit 105 via the imaging control unit 103. Note that, in the disclosure, imaging data captured by the imaging portion 12 will be described as image data.

The communication control unit 104 controls communication of the communication portion 14. The communication control unit 104 transmits data (correction table or the like) for luminance correction generated by the application execution unit 105 of the smartphone 1 to the display device including the display panel to be corrected. In the disclosure, as described above, data is transmitted to the display device by executing communication using Bluetooth (tradename), for example.

The application execution unit 105 executes various types of applications in the smartphone 1. Specifically, the application execution unit 105 executes processing in response to various types of information supplied from the touch acquisition unit 101, the communication control unit 104, and the like. In the present embodiment, the application execution unit 105 includes an imaging instruction unit 51, an imaging data acquisition unit 52, a detected luminance correction unit 53, a luminance correction data generation unit 54, and a correction table generation unit 55.

The imaging instruction unit 51 issues an instruction for imaging by using the imaging portion 12 to the user operating the smartphone 1. Specifically, the imaging instruction unit 51 causes the display portion 112 of the touch panel 11 of the smartphone 1 to display an image prompting an instruction for imaging in order to instruct the user to perform imaging by using the imaging portion 12. Note that, it is preferable to display an image on the display portion 112 of an instruction for imaging. However, a speaker (not illustrated) of the smartphone 1 may be caused to output a sound prompting an instruction for imaging. The details of the imaging instruction by the imaging instruction unit 51 will be described later.

The imaging data acquisition unit 52 acquires, as image data, imaging data captured by using the imaging portion 12 in response to an instruction for imaging from the imaging instruction unit 51 and sends the acquired image data to the detected luminance correction unit 53. The timing at which the imaging data acquisition unit 52 sends the image data to the detected luminance correction unit 53 is not particularly limited. For example, the imaging data acquisition unit 52 may transmit the image data to the detected luminance correction unit 53 each time the imaging data acquisition unit 52 acquires the image data or may acquire a predetermined number of pieces of image data and then collectively transmit the image data to the detected luminance correction unit 53.

The detected luminance correction unit 53 calculates in-plane distribution of detected luminance in an imaging range of the imaging portion 12 from a plurality of image data acquired by the imaging data acquisition unit 52. Then, using at least the calculated in-plane distribution of the detected luminance, the detected luminance correction unit 53 corrects the in-plane distribution of the detected luminance for one piece of image data among the plurality of image data acquired by the imaging data acquisition unit 52. The image data subjected to the luminance correction is sent to the luminance correction data generation unit 54. In the disclosure, the term “in-plane distribution of detected luminance” means imaging unevenness caused by the imaging portion 12 or the like included in the image data (luminance data) detected by the imaging portion 12 and indicates distribution of luminance components. In other words, the unevenness is caused by an imaging system irrelevant to a subject of which an image is to be captured (luminance unevenness of a display panel 21 of the disclosure).

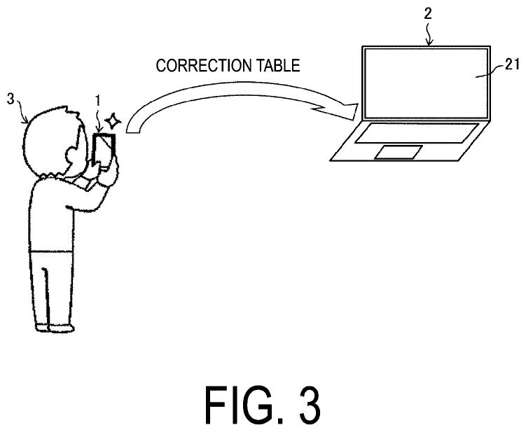

The detected luminance correction unit 53, the luminance correction data generation unit 54, and the correction table generation unit 55 constitute a correction data generation unit that generates correction data for performing the luminance correction of the display screen (for example, the display panel 21 of a display device 2 illustrated in FIG. 3) which is a correction target using the image data acquired by the imaging data acquisition unit 52. Here, the correction data includes luminance correction data generated by the luminance correction data generation unit 54 and the correction table generated by the correction table generation unit 55. The correction data is generated as follows.

The luminance correction data generation unit 54 analyzes the luminance component of the image data subjected to detected luminance correction sent from the detected luminance correction unit 53, and generates the luminance correction data. In the disclosure, the term “luminance component” refers to a specific numerical value of luminance at each position in the image data. The generation of the luminance correction data by the luminance correction data generation unit 54 will be described in detail later.

The correction table generation unit 55 generates a correction table for correcting the luminance of the display screen to be corrected from the luminance correction data generated by the luminance correction data generation unit 54. By using this correction table, interpolation processing or the like is applied to the image data to be corrected, and the luminance correction in an arbitrary color/gray scale is made to be possible. The generated correction table is stored in the storage portion 13 and transmitted from the communication portion 14 to the display device including the display panel to be corrected via the communication control unit 104, and stored in a nonvolatile memory in the display device. Thus, the display device can display an image with appropriate luminance distribution by reflecting the correction table stored in the nonvolatile memory on the image to be displayed.

Hereinafter, a method of correcting the luminance unevenness (luminance correction processing) of the display panel of the display device using the smartphone 1 including the above-described configuration will be described. Here, an example in which the luminance correction is performed by executing an application for luminance correction processing by the application execution unit 105 of the smartphone 1 will be described.

### Luminance Correction Processing

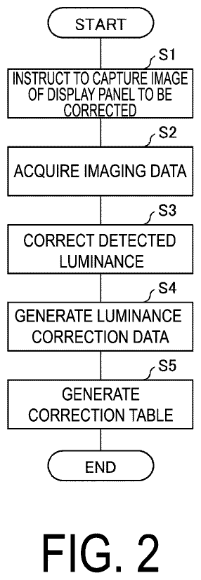

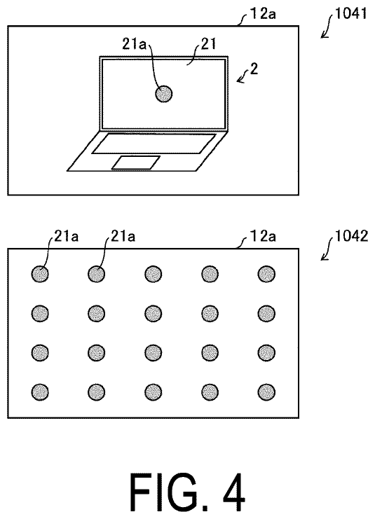

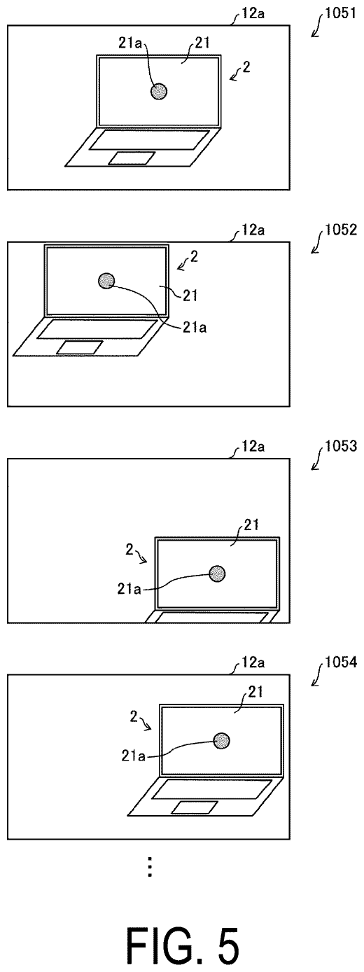

FIG. 2 is a flowchart illustrating a flow of processing when the application execution unit 105 in the smartphone 1 executes the application for luminance correction processing. FIG. 3 is a diagram illustrating an image in which a user 3 captures an image of the display panel 21 of the display device 2 using the smartphone 1. FIG. 4 is a diagram for illustrating how to capture a plurality of images of the display panel 21 of the display device 2 whose image is to be captured. FIG. 5 is a diagram illustrating an example of the image data captured by the imaging method illustrated in FIG. 4.

First, when the application for luminance correction processing is executed in the smartphone 1, the imaging instruction unit 51 issues an instruction for capturing an image of the display panel 21 to be corrected (step S1: first step). Specifically, the imaging instruction unit 51 issues, for example, an instruction for capturing an image of the display panel (display screen) 21 of the display device 2 to be corrected to the user 3 within the imaging range of the imaging portion 12 of the smartphone 1 used by the user 3, and further issues an instruction for capturing an image of the display panel 21 multiple times in which the display panel is moved to other positions within the imaging range of the imaging portion 12. Here, the display portion 112 of the touch panel 11 of the smartphone 1 may display an image that prompts an instruction for imaging (an instruction to take a plurality of photographs), or a speaker (not illustrated) of the smartphone 1 may output a sound that prompts an instruction for imaging.

As illustrated in FIG. 3, the user 3 captures an image of the display panel 21 of the display device 2 to be corrected, using the imaging portion 12, which is a camera of the smartphone 1, following an imaging instruction from the smartphone 1 operated by the user 3. At this time, while the main body of the smartphone 1 and the display panel 21 to be corrected are kept substantially parallel to each other, the images of display panels 21 are captured multiple times so that a position of the display panel 21 to be corrected in an imaging area 12a of the imaging portion 12 changes. As described above, when a plurality of images are captured, for example, as indicated by a reference sign 1041 in FIG. 4, in the imaging area 12a of the imaging portion 12 of the smartphone 1, the position of the display panel 21 is changed and imaging is repeated so that a circle 21a located substantially at the center of the display panel 21 of the display device 2 is distributed in the imaging area 12a as indicated by a reference sign 1042 in FIG. 4. At this time, the smartphone 1 gives guidance to the user 3 with a message or the like for the user to capture an image so that the display panel 21 is located at the center, the display panel 21 is located at the upper left corner, the display panel 21 is located at the lower right corner, the display panel 21 is located at the upper right corner, . . . , etc. By performing imaging in this way, for example, photographs of the image of the display panel 21 indicated by reference signs 1051, 1052, 1053, 1054, . . . in FIG. 5 are obtained. Note that, the circle 21a is not necessarily required to be displayed on the screen as long as the user 3 can perform imaging as described above by guidance for the user or the like.

In the example indicated by the reference sign 1042 in FIGS. 4, 20 positions corresponding to the circles 21 a are indicated. That is, an example in which 20 types of images are captured is illustrated. Note that, the number of types of photographs of the image of the display panel 21 is not limited to 20.

In addition, in the imaging area 12a, the positions of the locations corresponding to the circle 21a do not need to be particularly determined positions, but are preferably widely and evenly distributed positions in the imaging area 12a.

However, as the number of photographs of the image of the display panel 21 and the number of locations used for comparison (locations corresponding to the circle 21a positions) become larger, more accurate analysis becomes possible. The analysis here is analysis of the in-plane distribution of the detected luminance of the imaging portion 12 of the smartphone 1, which is executed in the following step S3.

Next, the imaging data acquisition unit 52 acquires the imaging data captured in step S1 as photographs (image data) (step S2: second step). The imaging data acquisition unit 52 sends the acquired image data to the detected luminance correction unit 53. In the disclosure, as indicated by the reference sign 1042 in FIG. 4, since it is assumed that there are 20 circles 21a, the imaging data acquisition unit 52 acquires 20 types of image data and sends the image data to the detected luminance correction unit 53 each time.

Subsequently, the detected luminance correction unit 53 calculates the in-plane distribution of the detected luminance in the imaging range of the imaging portion 12 from the 20 types of the image data from the imaging data acquisition unit 52, and using at least the calculated in-plane distribution of the detected luminance, the detected luminance correction unit 53 corrects the in-plane distribution of the detected luminance for one piece of the 20 types of image data from the imaging data acquisition unit 52 (step S3: corresponding to the detected luminance correction step of third step). Specifically, the detected luminance correction unit 53 first calculates the in-plane distribution of the detected luminance of the imaging portion 12 from the difference in the detected luminance of each of the 20 pieces of image data. Here, the in-plane distribution of the detected luminance in the imaging portion 12 of the smartphone 1 is analyzed by comparing the detected luminance at a specific location (for example, the position of the circle 21a at the center of the panel) of the display panel 21 to be corrected in the image data between the 20 pieces of image data. As a result of this analysis, when there is a difference between the detected luminance values, it is considered that the difference is due to the in-plane detected luminance dependence included in the imaging portion 12 of the smartphone 1. That is, in the captured 20 pieces of image data, since the luminance at the same location is originally the same, a difference does not occur in the detection value of the luminance. However, when a difference occurs in the detection value of the luminance, it can be said that the detected luminance of the imaging portion 12 itself of the smartphone 1 has in-plane dependence. Then, the detected luminance correction unit 53 sends the image data in which the in-plane distribution of the detected luminance is corrected to the luminance correction data generation unit 54.

The luminance correction data generation unit 54 analyzes the luminance component of the image data in which the in-plane distribution of the detected luminance is corrected by the detected luminance correction unit 53, and generates the luminance correction data (step S4: corresponding to a luminance correction data generation step of the third step). Specifically, the luminance correction data generation unit 54 analyzes the luminance component of the image data in which the in-plane distribution of the detected luminance has been corrected, and generates the luminance correction data for correcting the luminance unevenness of the display panel 21 from the analyzed result.

Finally, the correction table generation unit 55 generates a correction table from the luminance correction data generated by the luminance correction data generation unit 54 (step S5: corresponding to a correction table generation step of the third step). Here, the correction table for performing luminance correction of the display panel 21 so as to enable the luminance correction in an arbitrary color/gray scale is generated by applying interpolation processing or the like from the luminance correction data in each color and each gray scale. The generated correction table is stored in the storage portion 13 in the smartphone 1 and transmitted to the display device 2 via the communication portion 14, and stored in the built-in nonvolatile memory (not illustrated).

The smartphone 1 including the above-described configuration processes the plurality of image data obtained by capturing the plurality of pieces of image data in which the image of the display panel 21 to be corrected is captured while changing the location at which an image of the target is captured, removes luminance unevenness caused by the imaging portion 12, and generates image data of the display panel 21 to be corrected. Then, the luminance component of the image data from which the unevenness caused by the imaging portion 12 is removed is further analyzed, a correction table for correcting the luminance unevenness of the display panel 21 is generated and stored in the nonvolatile memory in the display panel 21, and the correction table is used on a TCON side of the display device 2 to enable image display in which the image correction is reflected.

### Advantageous Effects

In this way, since the luminance unevenness caused by the imaging portion 12 is taken into consideration, it is possible to appropriately correct the luminance unevenness of the display panel 21 even when there is the luminance unevenness caused by the imaging portion 12. Therefore, a generally used camera including a generally known camera of a smartphone can be widely used as the imaging portion 12. As a result, an effect of reducing the luminance unevenness of the display screen at low cost can be achieved.

Note that, in general, the gray scale of each pixel of the display panel 21 is associated with the luminance of the image data. Therefore, in the disclosure, each of the gray scales of a red sub-pixel, a green sub-pixel, and a blue sub-pixel of the display panel 21 may be analyzed instead of the luminance, and the luminance may be corrected through correction of the gray scale. This correction can also correct the above-described luminance unevenness of the display panel 21. Therefore, in the disclosure, the correction of the luminance of each pixel of the display panel 21 includes the correction performed through analysis and correction of the gray scale of each pixel of the display panel 21.

Here, when the Demura process is performed on the display panel 21 of the display device 2 in a bright room, the display panel 21 of the display device 2 has external light reflection (reflection), and the external light reflection may affect the luminance unevenness of the display panel 21. Therefore, when the Demura process is performed on the display panel 21 of the display device 2, it is preferable to perform imaging in a dark room in which there is no external light reflection. In a second embodiment described below, an example will be described in which the influence of external light reflection is removed when the Demura process is performed on the display panel 21 of the display device 2 in a bright room.

### Second Embodiment

Another embodiment of the disclosure will be described below. Further, members having the same functions as those of the members described in the above-described embodiments will be denoted by the same reference numerals and signs, and the description thereof will not be repeated for the sake of convenience of description.

### Removal of Influence of External Light Reflection (Reflection)

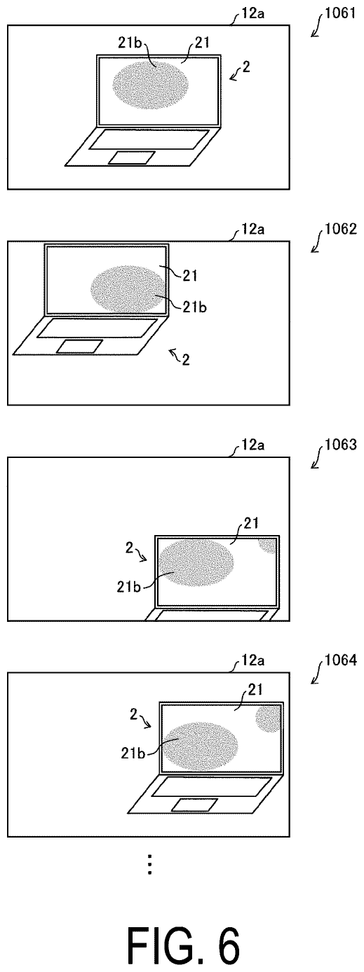

FIG. 6 is a diagram illustrating an example of a photograph of an image of a display panel 21 captured in a case in which the influence of external light reflection (reflection) of the display panel 21 is removed when the luminance unevenness of the display panel 21 of a display device 2 is corrected.

Under the same environment as when capturing a still image (including solid screen other than black display), the display panel 21 which is a correction target panel is set to black display (V0 display), and imaging is performed by an imaging portion 12 of a smartphone 1. At this time, since the black display is approximately 0 nits, only the influence of the external light reflection (reflection) appears within the panel area to be corrected in the image data. By detecting this as background noise and subtracting the background noise from the image data at the time of capturing a still image, the influence of external light reflection can be removed.

Here, the luminance correction data in consideration of external light reflection is generated by a detected luminance correction unit 53 and a luminance correction data generation unit 54 in an application execution unit 105 of the smartphone 1 described in the first embodiment. Specifically, the detected luminance correction unit 53 first analyzes an external light reflection component from at least one piece of image data among the plurality of image data acquired by an imaging data acquisition unit 52. Next, the detected luminance correction unit 53 subtracts the detected luminance corresponding to the external light reflection component from the detected luminance of the image data obtained by analyzing the external light reflection component, and then corrects the in-plane distribution of the detected luminance with respect to the image data from which the detected luminance corresponding to the external light reflection component has been subtracted. Thereafter, the luminance correction data generation unit 54 analyzes the luminance component of the image data subjected to the detected luminance correction in consideration of the external light reflection component by the detected luminance correction unit 53, and generates the luminance correction data.

Here, since there is a possibility that external light reflection (reflection) varies depending on an angle or the like at the time of capturing an image of the panel, a plurality of images are captured so that the position of the display panel 21 which is a panel to be corrected in an imaging area 12a of an imaging portion 12 of the smartphone 1 changes as in the case of the luminance correction data being generated in the first embodiment. To be specific, for example, as indicated by a reference sign 1061 in FIG. 6, the display panel 21 of the display device 2 is set to black display, and a plurality of images of the display panel 21 are captured so that an external light reflection region 21b changes within the imaging area 12a of the imaging portion 12. Also in this case, as in the first embodiment, the smartphone 1 gives guidance to the user 3 with a message or the like for the user to capture an image in which the display panel 21 is located at the center, the display panel 21 is located at the upper left corner, the display panel 21 is located at the lower right corner, the display panel 21 is located at the upper right corner, . . . , etc. By performing imaging in this way, for example, photographs of the image of the display panel 21 indicated by reference signs 1061, 1062, 1063, 1064, . . . in FIG. 6 are obtained. By analyzing a plurality of photographs of the image of the display panel 21 obtained in this way, the external light reflection component can be detected with higher accuracy.

### Advantageous Effects

As described above, by detecting the external light reflection component and calculating the in-plane distribution of the detected luminance with respect to the image data from which the external light reflection component is removed, the luminance correction in the display panel 21 can be performed with higher accuracy.

Note that, in the first embodiment and the second embodiment, since the position of the display panel 21 to be corrected displayed on a plurality of pieces of image data varies, it may be difficult to automatically use the methods described in the first embodiment and the second embodiment for display correction. A method of performing display correction by reducing the influence of the position of the display panel 21 described above will be described in a third embodiment below.

### Third Embodiment

Another embodiment of the disclosure will be described below. Further, members having the same functions as those of the members described in the above-described embodiments will be denoted by the same reference numerals and signs, and the description thereof will not be repeated for the sake of convenience of description.

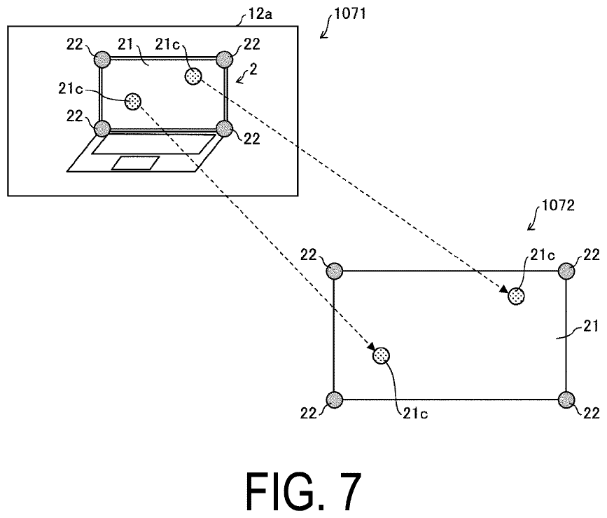

Coping with Panel Position Variation (1) FIG. 7 is a diagram for illustrating how to cope with panel position variations in the image data. Actually, the display screen of a display panel 21 to be corrected included in the image data is converted into an image having the number of pixels that can be displayed by the actual display panel 21. This conversion is performed by a luminance correction data generation unit 54 described in the first embodiment. That is, the luminance correction data generation unit 54 associates the position in the display screen of the display panel 21 to be corrected included in the image data subjected to the detected luminance correction by a detected luminance correction unit 53 with the position in the display screen of the display panel 21 to be actually corrected, converts the display data of the display screen to be corrected included in the image data into the display data to be displayed on the display screen of the actual display device, analyzes the luminance component in the converted display data, and generates the luminance correction data for performing the luminance correction of the display screen displaying the display data from the analyzed result.

Specifically, the luminance correction data generation unit 54 first detects four corners (four circles 22 in the drawing) of the display panel 21 of a display device 2 displayed in an imaging area 12a from the image data indicated by a reference sign 1071 in FIG. 7, and specifies coordinates in the imaging area 12a. Further, the luminance correction data generation unit 54 determines a coordinate conversion formula for performing conversion from the specified coordinates in the imaging area 12a to an actual position (pixel coordinates) in the display panel 21, for an arbitrary location (for example, circles 21c at two locations) within the display area of the display panel 21 in the imaging area 12a.

For each location (each pixel) in the display area of the display panel 21 in the imaging area 12a, the coordinates in the imaging area 12a are converted into the actual position (pixel coordinates) in the display panel 21. This conversion is executed by, for example, the luminance correction data generation unit 54 converting the coordinates in the imaging area 12a based on the coordinate conversion formula determined in the preceding process. Through the above-described processing, the position (pixel coordinates) of the display panel 21 in the imaging area 12a of an imaging portion 12 can be associated with the actual position (pixel coordinates) in the display panel of the actual display panel 21 to be corrected.

In this way, the luminance correction data generation unit 54 extracts the display area of the display panel 21 from the imaging area 12a of the imaging portion 12, and converts the extracted display area into an image (display data) having the number of pixels that can be displayed on the actual display panel 21, as indicated by a reference sign 1072 in FIG. 7. A luminance component of the converted display data is analyzed, and the luminance correction data for performing the luminance correction of the display screen displaying the display data is generated from the analyzed result.

Then, a correction table generation unit 55 generates a correction table for performing the luminance correction of the display screen from the luminance correction data generated by the luminance correction data generation unit 54. The correction table generated by the correction table generation unit 55 is sent to the display device 2 including the display panel 21, stored in the nonvolatile memory, and used for the luminance correction of the display data as necessary.

### Cope With Panel Position Variation (2)

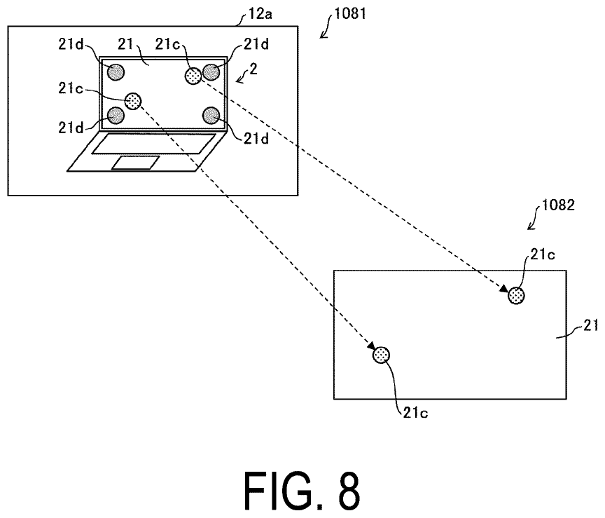

FIG. 8 is a diagram for illustrating how to cope with panel position variations in the image data. In the method illustrated in FIG. 7, the positions of the four corners (the four circles 22 in the drawing) of the display panel 21 in the imaging area 12a are detected and used as a reference for coordinate conversion, but as indicated by a reference sign 1081 in FIG. 8, a solid image including four points 21d serving as markers is displayed in the display screen of the display panel 21 in the imaging area 12a, and the positions of the four points 21d serving as the markers are used as a reference for coordinate conversion.

First, as indicated by the reference sign 1081 in FIG. 8, a solid image including the four points 21d serving as the markers is displayed on the display screen of the display panel 21 of the display device 2 displayed in the imaging area 12a, and is captured by the imaging portion 12 of a smartphone 1. The luminance unevenness caused by the imaging portion 12 of the smartphone 1 is removed for one piece of a plurality of captured image data. Coordinate conversion of the display panel 21 included in the image data obtained in this way is performed. This conversion is also performed by the luminance correction data generation unit 54 described in the first embodiment.

That is, the luminance correction data generation unit 54 first detects the four points 21d serving as the markers in the display panel 21 of the display device 2 displayed in the imaging area 12a from the image data indicated by the reference sign 1081 in FIG. 8, and specifies the coordinates in the imaging area 12a. Further, the luminance correction data generation unit 54 determines a coordinate conversion formula for performing conversion from the specified coordinates in the imaging area 12a to an actual position (pixel coordinates) in the display panel 21, for an arbitrary location (for example, the circles 21c at two locations) within the display area of the display panel 21 in the imaging area 12a.

For each location (each pixel) in the display area of the display panel 21 in the imaging area 12a, the coordinates in the imaging area 12a are converted into the actual position (pixel coordinates) in the display panel 21. This conversion is executed by, for example, the luminance correction data generation unit 54 converting the coordinates in the imaging area 12a based on the coordinate conversion formula determined in the preceding process. Through the above-described processing, the position (pixel coordinates) of the display panel 21 in the imaging area 12a of the imaging portion 12 can be associated with the actual position (pixel coordinates) in the display panel of the actual display panel 21 to be corrected.

In this way, the luminance correction data generation unit 54 extracts the display area of the display panel 21 from the imaging area 12a of the imaging portion 12, and converts the extracted display area into an image (display data) having the number of pixels that can be displayed on the actual display panel 21, as indicated by a reference sign 1082 in FIG. 8. A luminance component of the converted display data is analyzed, and the luminance correction data for performing the luminance correction of the display screen displaying the display data is generated from the analyzed result.

Then, the correction table generation unit 55 generates a correction table for performing the luminance correction of the display screen from the luminance correction data generated by the luminance correction data generation unit 54. The correction table generated by the correction table generation unit 55 is sent to the display device 2 including the display panel 21, stored in the nonvolatile memory, and used for the luminance correction of the display data as necessary.

Although an example in which the solid image including the four points 21d serving as the markers is displayed on the display panel 21 of the display device 2 displayed in the imaging area 12a has been described above, the number of markers displayed in the display panel 21 is not limited to four, and at least three points 21d serving as the markers may be displayed. Also in this case, at least the three points 21d are displayed in the display panel 21, the positions of the three points 21d are used as a reference for coordinate conversion, and the same procedure as described above is performed to generate a correction table.

In addition, since the size, color, and the like of the point 21d serving as the marker can be adjusted for convenience of detection, coordinate conversion can be performed more accurately than detection of four corners of the display panel 21 indicated by the reference sign 1071 in FIG. 7.

Note that, though the point 21d serving as the marker in the display screen of the display panel 21 is not necessary at the time of actual correction, the existing location of the point 21d serving as a marker can also be corrected with a certain accuracy by complementing the original luminance of the existing location of the point 21d serving as a marker from the luminance distribution around the marker. In order to perform correction with higher accuracy, it is preferable that the point 21d serving as the marker be smaller.

In the first embodiment through the third embodiment, as illustrated in FIG. 3, the smartphone 1 and the display device 2 constitute a display correction system that corrects the luminance unevenness of the display panel 21 of the display device 2. In the above-described display correction system, an example has been described in which the smartphone 1 performs processing up to generation of correction data for correcting the in-plane unevenness of the actual display panel 21, but the disclosure is not limited thereto. The processes up to the imaging instruction unit 51 and the imaging data acquisition unit 52 of the application execution unit 105 in the smartphone 1 may be performed on a smartphone 1 side, and the processes of the detected luminance correction unit 53, the luminance correction data generation unit 54, and the correction table generation unit 55 may be performed on a display device 2 side. Furthermore, the processes of the detected luminance correction unit 53, the luminance correction data generation unit 54, and the correction table generation unit 55 may be executed in a third device (including the cloud) other than the smartphone 1 and the display device 2. In any case, the correction table may finally be stored in the nonvolatile memory in the terminal to be corrected. Note that, though it is possible to store the correction table in an external region (for example, on the cloud) other than the nonvolatile memory and read the correction table each time, it is preferable to store the correction table in the nonvolatile memory in the terminal to be corrected in consideration of the reading time. In this way, it is possible to construct a display correction system with a high degree of freedom that matches the convenience of the user and the performance of each terminal.

### EXAMPLE

Here, processing for performing actual luminance correction of the display panel 21 will be described based on the matters described in the first embodiment through the third embodiment.

In this example, it is assumed that the luminance correction of the display panel 21 is performed in a bright room. For this reason, the following processes (A) and (B) are performed before capturing an image of the display panel 21. Note that, in a case in which the luminance correction of the display panel 21 is performed in a dark room, the following processes (A) and (B) are not necessary.

(A) A black screen (V0 solid screen) is displayed on the display panel 21 to be corrected, and a plurality of images are captured so that the position of the display panel 21 in the imaging portion 12 of the smartphone 1 changes while the main body of the smartphone 1 and the display panel 21 to be corrected are kept substantially parallel to each other. The number of image data to be captured here may be one, but it is preferable to capture two or more images.

(B) A peak (component) that is thought to be reflected light is detected from the image data captured in (A).

After performing processes (A) and (B), the display screen of the display panel 21 is changed to a solid screen of (red, green, blue, white)×(0 gray scale, 32 gray scale, 64 gray scale, 96 gray scale, 128 gray scale, 160 gray scale, 192 gray scale, 224 gray scale, 255 gray scale), for example, and the following processes (1) to (6) are repeated.

(1) An image of the display panel 21 to be corrected is captured (acquisition of image data used for correction). Here, a plurality of images of the display panel 21 are captured so that the position of the display panel 21 to be corrected in the imaging portion 12 of the smartphone 1 changes while the main body of the smartphone 1 and the display panel 21 to be corrected are kept substantially parallel to each other. That is, image data for obtaining correction data for the in-plane dependence of the detected luminance of the imaging portion 12 is acquired.

Note that, the process of (1) does not need to be performed for each display color and gray scale in order to shorten the processing time, and may be performed only for a specific color and a specific gray scale and applied to all colors and gray scales as long as a certain correction effect is obtained.

(2) Among the photographs of the images of the display panel 21 obtained in (1), find a photograph having the same shape as the reflected light peak (component) obtained in (B), and in a case in which the photograph is found, the intensity of the corresponding component is subtracted from the photograph of the image of the display panel 21 obtained in (1). That is, the external light reflection (reflection) is removed from the image data. On the other hand, among the photographs of the images of the display panel 21 obtained in (1), for a photograph in which a shape matching the reflected light peak (component) obtained in (B) is not found, it is determined that the photographs are without external light reflection (reflection), and no particular processing is performed.

(3) The in-plane distribution of the detected luminance of the camera (imaging portion 12) mounted on the smartphone 1 is calculated from the difference in the detected luminance between the plurality of image data obtained in (2).

(4) Correction of the in-plane distribution of the detected luminance obtained in (3) is applied to one piece of the plurality of image data obtained in (2). The corrected image data is an image in which the in-plane dependence of the detected luminance of the imaging portion 12 is removed. Furthermore, in a case in which the external light reflection is confirmed in the photograph in (2) and the external light reflection is removed from the image data, the image data obtained in (4) becomes an image in which the in-plane dependence of the detected luminance of the imaging portion 12 is removed and the external light reflection is removed.

(5) The image data obtained in (4) is analyzed, the position (pixel coordinates) of the display panel 21 to be corrected in the image data in the smartphone 1 is associated with the actual position (pixel coordinates) in the display panel 21 to be corrected, and the data of the image data in an in-plane location of the display panel 21 in (4) is converted into the actual data for the display panel 21.

(6) Since the data for the display panel 21 in (5) can be regarded as in-plane unevenness data in the display panel 21 for each color and gray scale, the luminance component is analyzed and converted into the luminance correction data.

From the luminance correction data for each color and each gray scale obtained through the series of processes (1) to (6) described above, a correction table that enables the luminance correction for an arbitrary color/gray scale is generated by interpolation processing or the like, and stored in the nonvolatile memory in the display panel 21 of the display device 2.

As a result, by reflecting the correction table stored in the nonvolatile memory on an image signal to be displayed in the display panel 21, the display device 2 can display an image with the appropriate luminance.

In the above series of processes (1) to (6), as described above, solid screens of 0 gray scale, 32 gray scale, 64 gray scale, 96 gray scale, 128 gray scale, 160 gray scale, 192 gray scale, 224 gray scale, and 255 gray scale were used for four colors of red, green, blue, and white, respectively. In this case, correction can be performed corresponding to the gray scale and color. Specifically, correction data for removing the in-plane unevenness may be generated for each gray scale or color. Note that, as for the correction related to the gray scale between the above-described gray scales such as 16 gray scales, the in-plane unevenness may be removed by interpolation processing.

Note that, some kind of still image is always displayed as in the case of signage, and switching to a solid screen may be difficult in some cases. In such a case, imaging is performed on a specific still image that is not a solid screen. Even in this case, according to the disclosure, the correction of the in-plane distribution of the detected luminance and the coordinate conversion can be performed from the image data of the still image obtained by imaging using the correction method of the in-plane distribution of the detected luminance and the method of the coordinate conversion described above. Then, the luminance correction data and the correction table can be generated by comparing the luminance component of the image data obtained by correcting the in-plane distribution of the detected luminance of the image data of the still image and the luminance component of the image data obtained by the coordinate conversion with the original luminance component of the still image. According to the present embodiment, the correction table may be stored in the nonvolatile memory and used for luminance correction. Therefore, in the disclosure, even when the display surface of the display panel 21 is a screen other than a solid screen, correction of the luminance unevenness of the display panel 21 can be performed appropriately.

Note that, in each of the above-described embodiments, an example in which the image data acquisition method according to the disclosure is applied to acquisition of the image data for performing the luminance correction of the display screen of the display device has been described. However, in a case in which this luminance correction is simultaneously performed for each of tristimulus values X, Y, and Z in the XYZ colorimetric system, chromaticity correction can also be achieved.

The disclosure is not limited to the embodiments described above, and various modifications may be made within the scope of the claims. Embodiments obtained by appropriately combining technical approaches disclosed in the different embodiments also fall within the technical scope of the disclosure. Furthermore, novel technical features can be formed by combining the technical approaches disclosed in each of the embodiments.

1. A method for acquiring image data to generate correction data for performing luminance correction or chromaticity correction of a display screen of a display device, the method comprising:
issuing an instruction for capturing an image of the display screen to be corrected to a user within an imaging range of an imaging device used by the user, and further issuing an instruction for capturing an image of the display screen multiple times in which the display screen is moved to other positions within the imaging range of the imaging device; and
performing acquisition of a plurality of imaging data as image data captured by the user based on the instruction issued in the issuing an instruction for capturing an image of the display screen.

2. The method for acquiring image data according to claim 1, further comprising:
generating correction data to perform luminance correction or chromaticity correction of the display screen by using a plurality of image data acquired in the performing acquisition of a plurality of imaging data as image data.

3. The method for acquiring image data according to claim 2,
wherein the generating correction data to perform luminance correction or chromaticity correction of the display screen includes
correcting in-plane distribution of detected luminance for one piece of image data among the plurality of image data acquired in the performing acquisition of a plurality of imaging data as image data by calculating in-plane distribution of detected luminance within the imaging range of the imaging device from the plurality of image data acquired in the performing acquisition of a plurality of imaging data as image data and using at least the calculated in-plane distribution of the detected luminance,
generating luminance correction data by analyzing a luminance component of the image data subjected to the luminance correction in the correcting in-plane distribution of detected luminance, and
generating a correction table to perform the luminance correction of the display screen from the luminance correction data generated in the generating luminance correction data.

4. The method for acquiring image data according to claim 3,
wherein the correcting in-plane distribution of detected luminance corrects, after analyzing an external light reflection component from at least one piece of the image data among the plurality of image data obtained in the performing acquisition of a plurality of imaging data as image data and subtracting the detected luminance corresponding to the external light reflection component from the detected luminance of the image data in which the external light reflection component is analyzed, the in-plane distribution of the detected luminance to the image data in which detected luminance corresponding to the external light reflection component is subtracted.

5. The method for acquiring image data according to claim 4,
wherein analysis of the external light reflection component is executed by using the image data in a case in which a black screen is displayed on the display screen.

6. The method for acquiring image data according to claim 3,
wherein the generating luminance correction data associates a position in the display screen to be corrected included in the image data subjected to the luminance correction in the correcting in-plane distribution of detected luminance and an actual position in the display screen to be corrected,
converts display data of the display screen to be corrected included in the image data to the display data displayed on the actual display screen of the display device,
analyzes a luminance component in the converted display data, and
generates the luminance correction data to perform the luminance correction of the display screen displaying the converted display data from the analyzed result.

7. The method for acquiring image data according to claim 6,
wherein at least three markers are displayed in the display screen to be corrected, and by referring to positions of the markers, a position within the display screen to be corrected included in the image data subjected to the luminance correction in the correcting in-plane distribution of detected luminance is associated with a position within the actual display screen to be corrected.

8. The method for acquiring image data according to claim 3,
wherein tristimulus values in an XYZ colorimetric system of image data to be subjected to luminance correction are corrected by the correcting in-plane distribution of detected luminance and the generating luminance correction data.

9. The method for acquiring image data according to claim 1,
wherein the display screen to be corrected is a solid screen entirely displayed in an identical color.

10. The method for acquiring image data according to claim 2,
wherein the display screen to be corrected is a solid screen entirely displayed in an identical color, and the issuing an instruction for capturing an image on the display screen, the performing acquisition of a plurality of imaging data as image data, and the generating correction data to perform luminance correction or chromaticity correction of the display screen are repeated for each display color and gray scale by changing a display color and a gray scale of the solid screen.

11. The method for acquiring image data according to claim 10,
wherein interpolation processing is used for the luminance correction data for each color and each gray scale to cope with correction for an arbitrary display color and gray scale.

12. The method for acquiring image data according to claim 1,
wherein the display screen to be corrected is a screen other than a solid screen entirely displayed in an identical color.

13. The method for acquiring image data according to claim 1,
wherein the display device is an organic Electro Luminescence (EL) panel.

14. The method for acquiring image data according to claim 1,
wherein the imaging device is at least one of a smartphone and a tablet terminal.

15. An image data acquisition device configured to acquire image data to generate luminance correction data for performing luminance correction or chromaticity correction of a display screen of a display device, the image data acquisition device comprising:
an imaging instruction unit configured to issue an instruction for capturing an image of the display screen to be corrected to a user within an imaging range of an imaging device used by the user, and configured to further issue an instruction for capturing an image of the display screen multiple times in which the display screen is moved to other positions within the imaging range of the imaging device; and
an imaging data acquisition unit configured to acquire a plurality of imaging data captured by the user as image data based on the instruction of the imaging instruction unit.

16. The image data acquisition device according to claim 15, further comprising:
a correction data generation unit configured to generate correction data for performing luminance correction or chromaticity correction of the display screen using a plurality of image data acquired by the imaging data acquisition unit.

17. The image data acquisition device according to claim 16,
wherein the correction data generation unit includes
a detected luminance correction unit configured to correct in-plane distribution of detected luminance for one piece of image data among the plurality of image data acquired by the imaging data acquisition unit by calculating the in-plane distribution of the detected luminance in an imaging range of the imaging device from the plurality of image data acquired by the imaging data acquisition unit and using at least the calculated in-plane distribution of the detected luminance,
a luminance correction data generation unit configured to analyze a luminance component of the image data subjected to the luminance correction by the detected luminance correction unit and to generate the luminance correction data, and
a correction table generation unit configured to generate a correction table for performing luminance correction of the display screen from the luminance correction data generated by the luminance correction data generation unit.

18. The image data acquisition device according to claim 17,
wherein tristimulus values in an XYZ colorimetric system of image data to be subjected to luminance correction are corrected by the detected luminance correction unit and the luminance correction data generation unit.

19. A terminal device, comprising:
the image data acquisition device according to claim 15; and
a transmission portion configured to transmit the correction data generated by the image data acquisition device to the display device including a display screen to be corrected.

20. A display correction system, comprising:
a display device including the terminal device according to claim 19 and configured to receive the correction data transmitted from the transmission portion of the terminal device,
wherein the display device corrects luminance or chromaticity of the display screen by using the received correction data.
